(19) United States
(12) Patent Application Publication
(10) Pub. No.: US 2004/0211791 A1
(43) Pub. Date: Oct. 28, 2004

(54) Device for dispensing a fluid product with closure system

(76) Inventors: Ludovic Petit, Vitot (FR); Laurent Arghyris, Sotteville-Les-Rouen (FR)

Correspondence Address: SUGHRUE MION, PLLC, 2100 PENNSYLVANIA AVENUE, N.W., SUITE 800, WASHINGTON, DC, 20037, US

(21) Appl. No.: 10/031,599

(22) PCT Filed: Jul. 26, 2000
(86) PCT No.: PCT/FR00/02151

(30) Foreign Application Priority Data
Jul. 28, 1999 (FR) 99/09798

(51) Int. Cl. G01F 11/06

(52) U.S. Cl. 222/321.3; 222/321.9

(57) ABSTRACT

A fluid dispenser device for dispensing a fluid, the fluid dispenser device comprising a fluid reservoir (10), a dispensing member (20), such as a pump, mounted on said reservoir (10), and a dispensing head (30) provided with a dispensing orifice (31) and mounted on said dispensing member (20) to move between a rest position and a dispensing position, said fluid dispenser device being characterized in that it further comprises a closure system (40) fixed to said reservoir (10) and comprising a closure element (41) suitable for closing off the dispensing orifice (31) from the outside when the dispensing head (30) is in the rest position, said closure system (40) further comprising passageway means (42), such as an opening, co-operating with said dispensing orifice (31) when the dispensing head (30) is in the dispensing position, and making it possible for fluid to be expelled through said dispensing orifice (31).

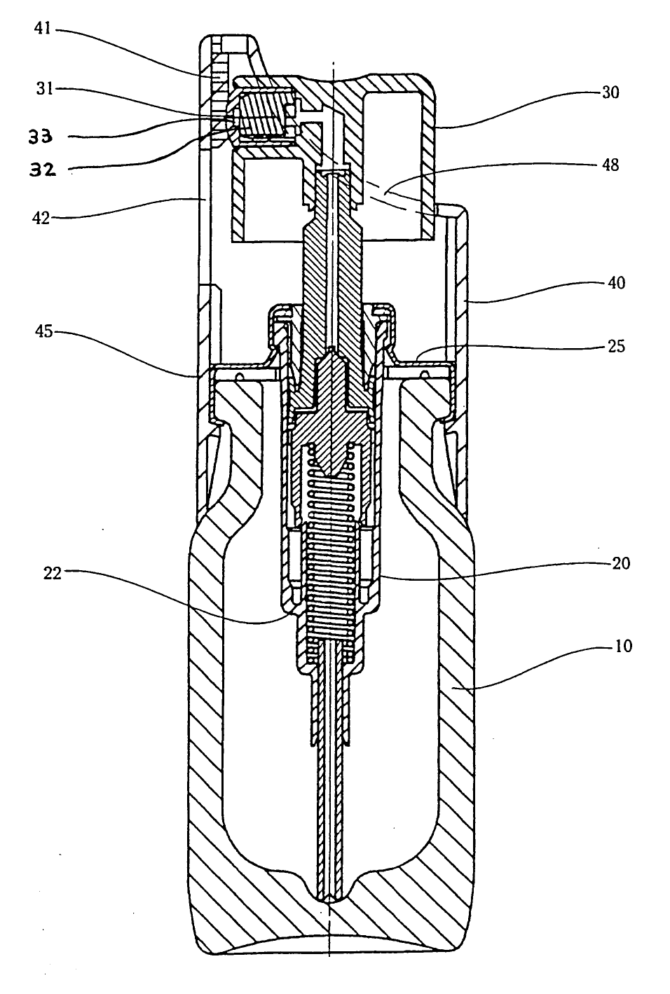

The present invention relates to a fluid dispenser device, and more particularly to a fluid dispenser device including a closure system.

It is well known from the state of the art that closure means can be used to close off the dispensing orifice of a fluid dispenser device in leaktight manner between successive occasions on which the device is actuated. Two different types of closure means are generally used. Thus firstly, Document FR-2 750 406 discloses a removable cap provided with a closure element, said cap being removed and put back in place by the user every time the dispenser is used, respectively before it is used and after it has been used. That type of closure means suffers from the drawback that closure is not independent of the user, and therefore that if ever the user forgets to put the closure cap back in place after the device has been actuated, then closure is not achieved. In addition, that system requires the user to perform additional manipulation, namely removing the closure cap and then putting it back in place, which can be a drawback, in particular for elderly people, the disabled, or children. Secondly, it is also known that closure means can be disposed in the dispensing head, downstream from the dispensing orifice. Such closure systems do not suffer from the preceding drawback because they are automatic, and therefore independent of the user, but they do suffer from the drawback, in particular in spray devices, of modifying the spray profile, and thus of preventing the fluid from being sprayed in proper and exactly reproducible manner each time the device is actuated. Furthermore, because they are positioned downstream from the dispensing orifice, such closure systems do not avoid the problem of a small quantity of fluid remaining on the zone situated around the dispensing orifice, outside it, after the device has been actuated. Such small quantities of fluid can then dry and block the dispensing orifice totally or partially, or can oxidize and be dispensed when the device is next actuated.

An object of the present invention is to provide a fluid dispenser device including a closure system that does not reproduce the above-mentioned drawbacks.

An object of the present invention is thus to provide a fluid dispenser device including a closure system in which closure is achieved independently of the user.

Another object of the present invention is to provide such a fluid dispenser device that guarantees proper and reproducible spraying each time it is actuated.

Yet another object of the present invention is to provide such a fluid dispenser device that prevents any risk of the dispensing orifice becoming blocked between successive occasions on which the device is actuated.

A further object of the present invention is to provide such a fluid dispenser device including a closure system that prevents any oxidation of the fluid around said dispensing orifice after the dispenser is actuated, every time it is actuated.

A further object of the present invention is to provide such a fluid dispenser device including a closure system that is simple and inexpensive to make, and that is easily adaptable to existing dispensing heads.

The present invention thus provides a fluid dispenser device for dispensing a fluid, the fluid dispenser device comprising a fluid reservoir, a dispensing member, such as a pump, mounted on said reservoir, and a dispensing head provided with a dispensing orifice and mounted on said dispensing member to move between a rest position and a dispensing position, the fluid dispenser device further comprising a closure system fixed to said reservoir and comprising a closure element suitable for closing off the dispensing orifice from the outside when the dispensing head is in the rest position, said closure system further comprising passageway means, such as an opening, co-operating with said dispensing orifice when the dispensing head is in the dispensing position, and making it possible for fluid to be expelled through said dispensing orifice.

Advantageously, said closure system is formed such as to make it possible for the dispensing head to be actuated manually by a user.

Advantageously, said dispensing head is mounted to move axially and the dispensing orifice is directed radially, said closure system being implemented in the form of a hollow sleeve disposed around said dispensing head, said hollow sleeve having, on one side, the opening and the closure element disposed above said opening, and, on the other side, a cutout through which the dispensing head projects so that it can be actuated by the user.

Preferably, said dispensing member has an initial dead stroke, actuating of said dispensing member starting only after the dispensing head has travelled over said dead stroke, when the dispensing orifice co-operates with said passageway means in said closure system.

Preferably, while the dispensing head is returning from its dispensing position to its rest position, after the dispensing member has been actuated, the closure element slides snugly over the zone situated around the dispensing orifice, so as to remove any trace of fluid at said dispensing orifice totally.

Advantageously, said closure system is snap-fastened to the neck of the reservoir.

Advantageously, said dispensing head includes a spray nozzle insert for limiting the dead volume, and a spray profile for ensuring that the product is sprayed when the dispensing member is actuated.

The characteristics and advantages of the present invention appear more clearly from the following detailed description of a particular embodiment of it, given by way of non-limiting example and with reference to the accompanying drawing, in which the sole FIGURE is a diagrammatic section view of a fluid dispenser device of the present invention, in the rest position.

The dispenser device includes a reservoir 10 on which a dispenser member 20, such as a precompression pump in the example shown in the FIGURE, is mounted. The pump 20 may be fixed to the reservoir 10 by any means, and in particular by a screw-on, snap-fastenable, or crimpable fixing ring 25. A dispensing head 30 is mounted on said pump 20 to actuate it, said head 30 being provided with a dispensing orifice 31, and being mounted to move axially between a rest position and a dispensing position. Advantageously, the dispensing head 30 may be moved from its rest position to its dispensing position by a finger of a user exerting pressure on its top surface, and it may be returned from its dispensing position by the return spring 22 of the pump 20.

In the invention, the fluid dispenser device further includes a closure system 40 fixed to the reservoir 10. In the example shown, the closure system 40 is snap-fastenable to the neck of the reservoir 10 around the fixing ring 25, but other means for fixing the closure system 40 to the reservoir 10 may be imagined. In the example shown in the FIGURE, the closure system 40 comprises a hollow sleeve 45 which incorporates a closure element 41 co-operating with the dispensing orifice 31 in the dispensing head 30 when said head is in the rest position, and an opening 42 which co-operates with the dispensing orifice 31 when the dispensing head 30 is in the dispensing position to enable fluid to be expelled through said dispensing orifice 31 and through said opening 42. In the embodiment shown in the FIGURE, the dispensing orifice 31 is directed radially in the dispensing head 30, which can be moved axially between its rest position and its dispensing position. The closure element 41 is thus disposed on the inside side wall of the hollow sleeve 45, above the opening 42. In which case, the pump 20 preferably has an initial dead stroke so that fluid expulsion starts only after said dead stroke, when the dispensing orifice 31 is situated facing the opening 42. To facilitate actuating of the dispenser device, the closure system 40, and in particular the hollow sleeve 45, is provided with a cutout 48 on the side opposite from the side having the closure element 41 and the window 42, so that the dispensing head 30 projects through said cutout 48, thereby making it easy for the user to press on said head 30 from the outside. Naturally, the cutout 48 in the sleeve 45 may be of any shape.

The closure element 41 may be of any suitable shape and may be made of any suitable material. For example, it may be in the form of a stopper wad. It may also contain a bacteriostatic and/or oligodynamic material. The opening 42 is advantageously in the form of a window provided in the side wall of the hollow sleeve 45 and whose dimensions are suitable for avoiding obstructing expulsion of the fluid.

The closure element 41 removes any trace of fluid in this zone that remains after the dispenser has been actuated. Thus, there is no risk of even a very small quantity of fluid oxidizing after the dispenser has been actuated, and then being dispensed when the dispenser is next actuated. Similarly, there is no risk of even a very quantity of fluid drying and totally or partially blocking the dispensing orifice, which could degrade the quality of the spraying. The closure element thus advantageously performs a cleaning function whereby it cleans the dispensing orifice 31. Advantageously, while the dispensing head 30 is returning from its dispensing position to its rest position, the closure element 41 slides snugly over the outside surface of the zone situated around the dispensing orifice 31 of the dispensing head 30. This further improves said cleaning function.

Preferably, the present invention is applied to a spray device having a spray nozzle insert for limiting the dead volume, and a spray profile for guaranteeing proper spraying of the fluid each time the dispenser is actuated. The present invention thus makes it possible to guarantee absolutely leaktight closure, independently of the user, and without modifying in any way the spray profile or therefore the proper shape of the spray delivered when the dispenser is actuated.

The present invention is described with reference to a particular embodiment in which the dispensing orifice 31 is directed radially, and the dispensing head 30 is mounted to move axially. However, it is possible to apply the present invention to any other type of dispensing head, e.g. a pivotally-mounted dispensing head, and to a dispensing orifice directed otherwise, naturally provided that the dispensing head moves relative to the closure system fixed to the reservoir, to enable the dispensing orifice to be moved between the closure element and the opening in the closure system.

Other modifications may also be imagined without going beyond the ambit of the present invention, whose scope is defined only by the accompanying claims. For example, the dispensing member may be of any type, the precompression pump shown in the FIGURE being merely an advantageous embodiment.

1. A fluid spray device for spraying a fluid, the fluid spray device comprising a fluid reservoir (10), a dispensing member (20) mounted on said reservoir (10), and a dispensing head (30) provided with a dispensing orifice (31) and mounted on said dispensing member (20) to move between a rest position and a dispensing position, said dispensing head (30) including a spray nozzle insert (32) for limiting the dead volume, and a spray profile (33) for ensuring that the product is sprayed when the dispensing member (20) is actuated, the device further comprising a closure system (40) fixed to said reservoir (10) and comprising a closure element (41) suitable for closing off the dispensing orifice (31) from the outside when the dispensing head (30) is in the rest position, said closure system (40) further comprising passageway means (42) co-operating with said dispensing orifice (31) when the dispensing head (30) is in the dispensing position, and making it possible for fluid to be expelled through said dispensing orifice (31), said fluid spray device being characterized in that said dispensing member (20) has an initial dead stroke, actuating of said dispensing member (20) starting only after the dispensing head (30) has traveled over said dead stroke, when the dispensing orifice (31) is situated facing said passageway means (42) in said closure system (40).

2. A device according to claim 1, in which said closure system (40) is formed such as to make it possible for the dispensing head (30) to be actuated manually by a user.

3. A device according to claim 1, in which the dispensing head (30) is mounted to move axially and the dispensing orifice (31) is directed radially, said closure system (40) being implemented in the form of a hollow sleeve (45) disposed around said dispensing head (30), said hollow sleeve (45) having, on one side, the opening (42) and the closure element (41) disposed above said opening (42), and, on another side, a cutout through which the dispensing head (30) projects so that it can be actuated by the user.

4. A device according to claim 1, in which, while the dispensing head (30) is returning from its dispensing position to its rest position, after the dispensing member (20) has been actuated, the closure element (41) slides snugly over the zone situated around the dispensing orifice (31), so as to remove any trace of fluid at said dispensing orifice (31) totally.

5. A device according to claim 1, in which said closure system (40) is snap-fastened to a neck of the reservoir (10).

6. The device according to claim 1, wherein the dispensing member is a pump.

7. The device according to claim 1, wherein the passageway means is an opening.

8. A fluid spray device for spraying a fluid, comprising:
a fluid reservoir containing a fluid;
a dispensing member to the reservoir; and
a dispensing head provided with a dispensing orifice, the dispensing head mounted to the dispensing member to move between a rest position and a dispensing position, and wherein the dispensing head comprises a spray nozzle that sprays a mist of the fluid;
the spray device further comprising:
a closure system fixed to the fluid spray device so as to remain immobile when the dispensing head moves between the rest position and the dispensing position;
a closure element that closes off the dispensing orifice from the outside when the dispensing head is in the rest position; and
a passageway positioned to be in front of the dispensing orifice when the dispensing head is in the dispensing position, so that fluid is expelled through the dispensing orifice and the passageway.

9. The device according to claim 8, wherein the dispensing member has an initial dead stroke, so that actuation of the dispensing member starts only after the dispensing head has traveled over the dead stroke and the dispensing orifice is disposed facing the passageway.

10. The device according to claim 8, wherein, after the dispensing head is released to move to the rest position, the dispensing orifice moves upward into sliding contact with the closure element.
